(19) United States
(12) Patent Application Publication
(10) Pub. No.: US 2026/0134173 A1
(43) Pub. Date: May 14, 2026

(54) SYSTEM AND METHOD OF CAUSAL COMPOSITION DIFFUSION FOR CLOSED LOOP TRAFFIC GENERATION

(71) Applicant: GM Cruise Holdings, LLC, San Francisco, CA (US)

(72) Inventors: Haohong Lin, Pittsburgh, PA (US); Hongge Chen, Mountain View, CA (US); Eric Wolff, Zephyr Cove, NV (US)

(73) Assignee: GM Cruise Holdings, LLC, San Francisco, CA (US)

(21) Appl. No.: 19/330,413

(22) Filed: Sep. 16, 2025

Related U.S. Application Data
(60) Provisional application No. 63/720,114, filed on Nov. 13, 2024.

(51) Int. Cl. G06F 30/27; G01M 17/007; G06F 111/04; G06N 5/025

(52) U.S. Cl. CPC G06F 30/27; G01M 17/007; G06N 5/025; G06F 2111/04

(57) ABSTRACT

A method includes receiving initial conditions for a traffic scenario including a plurality of interacting agents, the initial conditions defining states of the plurality of agents, identifying a causal structure among the plurality of agents based on the states of the plurality of agents, and ranking the plurality of agents based on the identified causal structure to determine a subset of key agents being most influential with respect to a controllability objective. For each agent of the plurality of agents, the method includes generating a future trajectory using a reverse sampling process of a diffusion model, and guiding the reverse sampling process by selectively applying a gradient of the controllability objective only to the determined subset of key agents.

### CROSS-REFERENCE TO RELATED APPLICATION

This application claims priority under 35 U.S.C. § 119 (e) to U.S. Provisional Application Ser. Number 63/720,114, filed Nov. 13, 2024. The disclosure of this prior application is considered part of the disclosure of this application and is hereby incorporated by reference in its entirety.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to computer-implemented simulation and, more particularly, to systems and methods for generating realistic and controllable traffic scenarios for the testing and validation of autonomous vehicles (Avs). The development and validation of safe and reliable AVs depend heavily on rigorous testing in a wide variety of driving scenarios. While real-world testing is indispensable, it is impractical and often dangerous to rely on it to cover the vast number of potential interactions, particularly rare but safety-critical “long-tail” events. Consequently, high-fidelity simulation has become an essential tool for evaluating AV performance.

An effective traffic simulator must generate scenarios that are both realistic and controllable. Realism ensures that the simulated behaviors of surrounding agents (e.g., other cars, pedestrians) accurately reflect the complex, nuanced, and often unpredictable nature of real-world interactions. Controllability allows developers and testers to specifically create and analyze challenging situations, such as forcing a near-miss or a collision, to systematically probe the limits of an AV's capabilities. However, existing approaches to traffic simulation struggle to adequately balance these two often-competing objectives. Data-driven methods, which learn from large datasets of real-world driving, can produce realistic common behaviors but often fail to generate novel, safety-critical scenarios that are rare in the training data. Furthermore, when used in a closed-loop setting where the simulation evolves over time, these models can suffer from compounding errors, causing the simulation to drift into unrealistic states.

Conversely, rule-based approaches offer precise control but often produce behaviors that feel scripted, rigid, and unrealistic, as they fail to capture the adaptive decision-making of human drivers. More recent deep generative models, including diffusion models, have shown promise but still face a fundamental challenge: a conflict between the objectives of realism and controllability. The process of guiding a simulation towards a specific, user-defined outcome (e.g., a collision) often requires generating agent behaviors that are improbable and deviate significantly from realistic patterns learned from data. This “gradient conflict” means that increasing controllability often comes at the direct expense of realism, and vice-versa. Therefore, a need exists for a traffic scenario generation system that can resolve this conflict, enabling the creation of scenarios that are simultaneously highly realistic and precisely controllable, particularly for the generation of safety-critical events.

### SUMMARY

One aspect of the disclosure provides a computer-implemented method of casual composition diffusion for closed loop traffic generation that when executed on data processing hardware causes the data processing hardware to perform operations that include receiving initial conditions for a traffic scenario including a plurality of interacting agents, the initial conditions defining states of the plurality of agents and identifying a causal structure among the plurality of agents based on the states of the plurality of agents, the causal structure defining causal influences between agents of the plurality of agents. The operations also include ranking the plurality of agents based on the identified causal structure to determine a subset of key agents being most influential with respect to a controllability objective. For each agent of the plurality of agents, the operations further include generating a future trajectory using a reverse sampling process of a diffusion model, and guiding the reverse sampling process by selectively applying a gradient of the controllability objective only to the determined subset of key agents, while guidance for remaining agents in the plurality of agents is determined based on the identified causal structure, thereby generating a final traffic scenario that satisfies the controllability objective while maintaining realism.

Implementations of the disclosure may include one or more of the following optional features. In some implementations, identifying the causal structure includes generating a Decision Causal Graph (DCG), nodes of the DCG representing agents and edges representing causal dependencies for future actions. In these implementations, the DCG may be generated using a scene encoder with a factorized attention mechanism, where causal connections are identified based on at least one of attention weights or kinematic factors between the plurality of agents. Here, the kinematic factors may include a time-to-collision (TTC) value between pairs of agents of the plurality of agents.

In some examples, ranking the plurality of agents includes performing a graph-based analysis on the identified causal structure to determine a degree of interactivity for each agent of the plurality of agents. In some implementations, guiding the reverse sampling process further includes applying a classifier-free guidance component. Here, the classifier-free guidance component includes a weighted combination of an unconditional distribution based on an agent's own history and an intervened distribution based on causal parents of the agent as defined by the causal structure.

In some examples, the controllability objective is associated with generating a safety-critical event. In these examples, the safety-critical event may include one of a collision between at least two agents, an off-road event for at least one agent, or a near-miss event. In some implementations, the diffusion model is formulated as a constrained optimization problem within a Constrained Factored Markov Decision Process (CFMDP). Here, the controllability objective is maximized subject to a realism constraint. In some examples, the diffusion model is a denoising diffusion probabilistic model (DDPM) and the reverse sampling process iteratively denoises a noise vector to produce each of the future trajectories.

Another aspect of the disclosure provides a system for casual composition diffusion for closed loop traffic generation including data processing hardware and memory hardware in communication with the data processing hardware. The memory hardware stores instructions that when executed by the data processing hardware cause the data processing hardware to perform operations that include receiving initial conditions for a traffic scenario including a plurality of interacting agents, the initial conditions defining states of the plurality of agents and identifying a causal structure among the plurality of agents based on the states of the plurality of agents, the causal structure defining causal influences between agents of the plurality of agents. The operations also include ranking the plurality of agents based on the identified causal structure to determine a subset of key agents being most influential with respect to a controllability objective. For each agent of the plurality of agents, the operations further include generating a future trajectory using a reverse sampling process of a diffusion model, and guiding the reverse sampling process by selectively applying a gradient of the controllability objective only to the determined subset of key agents, while guidance for remaining agents in the plurality of agents is determined based on the identified causal structure, thereby generating a final traffic scenario that satisfies the controllability objective while maintaining realism.

This aspect may include one or more of the following optional features. In some implementations, identifying the causal structure includes generating a Decision Causal Graph (DCG), nodes of the DCG representing agents and edges representing causal dependencies for future actions. In these implementations, the DCG may be generated using a scene encoder with a factorized attention mechanism, where causal connections are identified based on at least one of attention weights or kinematic factors between the plurality of agents. Here, the kinematic factors may include a time-to-collision (TTC) value between pairs of agents of the plurality of agents.

In some examples, ranking the plurality of agents includes performing a graph-based analysis on the identified causal structure to determine a degree of interactivity for each agent of the plurality of agents. In some implementations, guiding the reverse sampling process further includes applying a classifier-free guidance component. Here, the classifier-free guidance component includes a weighted combination of an unconditional distribution based on an agent's own history and an intervened distribution based on causal parents of the agent as defined by the causal structure.

In some examples, the controllability objective is associated with generating a safety-critical event. In these examples, the safety-critical event may include one of a collision between at least two agents, an off-road event for at least one agent, or a near-miss event. In some implementations, the diffusion model is formulated as a constrained optimization problem within a Constrained Factored Markov Decision Process (CFMDP). Here, the controllability objective is maximized subject to a realism constraint. In some examples, the diffusion model is a denoising diffusion probabilistic model (DDPM) and the reverse sampling process iteratively denoises a noise vector to produce each of the future trajectories.

One aspect of the disclosure provides a computer-implemented method of casual composition diffusion for closed loop traffic generation that when executed on data processing hardware causes the data processing hardware to perform operations that include receiving initial conditions for a traffic scenario including a plurality of interacting agents, the initial conditions defining states of the plurality of agents, and identifying a causal structure among the plurality of agents based on the states of the plurality of agents, the causal structure defining causal influences between agents of the plurality of agents. The operations also include ranking the plurality of agents based on the identified causal structure to determine a subset of key agents being most influential with respect to a controllability objective. For each agent of the plurality of agents, the operations further include generating a future trajectory using a reverse sampling process of a diffusion model, the reverse sampling process guided by selectively applying a gradient of the controllability objective only to the determined subset of key agents.

The details of one or more implementations of the disclosure are set forth in the accompanying drawings and the description below. Other aspects, features, and advantages will be apparent from the description and drawings, and from the claims.

### BRIEF DESCRIPTION OF THE DRAWINGS

The drawings described herein are for illustrative purposes only of selected configurations and are not intended to limit the scope of the present disclosure.

FIG. 1 is a schematic view of an exemplary system for casual composition diffusion for closed loop traffic generation.

FIG. 2 is a schematic view of example components of a casual composition diffusion model of the system of FIG. 1.

FIG. 3 is a schematic view of example components of the casual composition diffusion model of the system of FIG. 1.

FIG. 4 is a flowchart of an exemplary arrangement of operations for a method of causal composition diffusion for closed loop traffic generation.

FIG. 5 is a flowchart of an exemplary arrangement of operations for a method of causal composition diffusion for closed loop traffic generation.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICS (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

The development and validation of safe and reliable A Vs depend heavily on rigorous testing in a wide variety of driving scenarios. While real-world testing is indispensable, it is impractical and often dangerous to rely on it to cover the vast number of potential interactions, particularly rare but safety-critical “long-tail” events. Consequently, high-fidelity simulation has become an essential tool for evaluating AV performance. An effective traffic simulator must generate scenarios that are both realistic and controllable. Realism ensures that the simulated behaviors of surrounding agents (e.g., other cars, pedestrians) accurately reflect the complex, nuanced, and often unpredictable nature of real-world interactions. Controllability allows developers and testers to specifically create and analyze challenging situations, such as forcing a near-miss or a collision, to systematically probe the limits of an AV's capabilities. However, existing approaches to traffic simulation struggle to adequately balance these two often-competing objectives. Data-driven methods, which learn from large datasets of real-world driving, can produce realistic common behaviors but often fail to generate novel, safety-critical scenarios that are rare in the training data. Furthermore, when used in a closed-loop setting where the simulation evolves over time, these models can suffer from compounding errors, causing the simulation to drift into unrealistic states.

Conversely, rule-based approaches offer precise control but often produce behaviors that feel scripted, rigid, and unrealistic, as they fail to capture the adaptive decision-making of human drivers. More recent deep generative models, including diffusion models, have shown promise but still face a fundamental challenge: a conflict between the objectives of realism and controllability. The process of guiding a simulation towards a specific, user-defined outcome (e.g., a collision) often requires generating agent behaviors that are improbable and deviate significantly from realistic patterns learned from data. This “gradient conflict” means that increasing controllability often comes at the direct expense of realism, and vice-versa. Therefore, a need exists for a traffic scenario generation system that can resolve this conflict, enabling the creation of scenarios that are simultaneously highly realistic and precisely controllable, particularly for the generation of safety-critical events.

The present system and method generate realistic and controllable closed-loop traffic scenarios that overcome the aforementioned limitations of the prior art. The system and method include a diffusion model, referred to as a Causal Composition Diffusion Model (CCDiff), that resolves the inherent conflict between realism and controllability by identifying and leveraging the underlying causal structure of interactions within a traffic scene. The method formulates the scenario generation task as a constrained optimization problem, aiming to maximize a user-defined controllability objective (e.g., causing a safety-critical event) while satisfying a realism constraint. At its core, the system employs a diffusion model to generate agent trajectories. The key innovation lies in how this generation process is guided.

First, a causal reasoner module analyzes the scene to automatically discover a Decision Causal Graph (DCG), which maps the cause-and-effect relationships between agents. Based on this graph, agents are ranked by their influence and interactivity, identifying a small subset of key agents critical to achieving the desired outcome. Second, a novel causal composition guidance mechanism is used to steer the CCDiff's generation process. This guidance is structured and selective. A gradient related to the controllability objective is applied only to the identified key agents. This focused intervention efficiently steers the scenario toward the desired outcome. Simultaneously, the behavior of all other agents is guided by the identified causal structure, ensuring their actions remain consistent and realistic within the context of the scene. By decoupling the guidance in this manner, the system avoids the gradient conflicts that plague prior art methods, thereby achieving a superior balance of both realism and controllability.

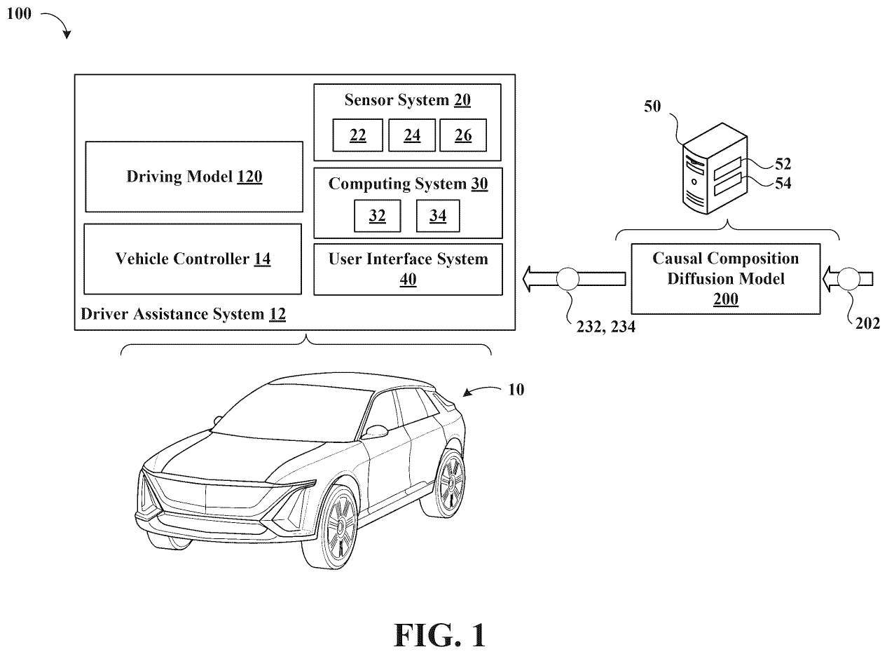

Referring to FIG. 1, a system 100 for casual composition diffusion for closed loop traffic generation is shown. The system 100 includes a remote computing system 50 and an autonomous agent. While the autonomous agent is depicted as a vehicle 10, the systems and methods described herein are broadly applicable to other types of autonomous agents. Such agents may include, but are not limited to, autonomous mobile robots (AMRs) operating in warehouses, robotic manipulators performing tasks in dynamic environments, unmanned aerial vehicles (UAVs), or agricultural and construction equipment. Furthermore, the principles may be applied to simulation systems for modeling agent behavior, such as in air traffic control systems or for pedestrian flow analysis. The remote computing system 50 may be a single computer, multiple computers, or a distributed system, such as a cloud computing environment, having data processing hardware 52 and memory 54. The memory 54 stores instructions that, when executed by the data processing hardware 52, configure the remote computing system 50 to operate as a causal composition diffusion model 200. The causal composition diffusion model 200 is configured to generate a scenario for a future trajectory 234, which is then deployed to validate a driving model 120 executed by the onboard driving assistance system 12. Here, the future trajectory 234 may form a final traffic scenario 232 that satisfies a controllability objective of the casual composition diffusion model 200. As used herein, the controllability objective may include generating a safety critical event such as, without limitation, a collision, an off-road event, a near-miss event, or an over-speed event. While described as a remote system, in some implementations, the functionality of the causal composition diffusion model 200 may be performed in whole or in part on computing resources located within the vehicle 10.

After the causal composition diffusion model 200 generates the future trajectory 234, the causal composition diffusion model 200 provides the future trajectory 234 for testing and validating an inference task performed by the driving model 120. The future trajectory 234 may be deployed to a mobile platform, such as the vehicle 10 shown, for execution by an onboard controller 14. The disclosed methods also extend beyond perception and control tasks. The vehicle controller 14 is part of an onboard control system, such as the driving assistance system 12 shown, which also includes an onboard computing system 30 with its own data processing hardware 32 and memory 34, a sensor system 20, a user interface system 40, and a network interface (not shown). The vehicle controller 14 uses the driving model 120 to perform an inference task, which involves processing real-time sensor data from the sensor system 20. The sensor system 20 may include various sensors such as one or more cameras 22, radar sensors 24, or lidar sensors 26. The output of the inference task is provided to one or more functions of the driving assistance system 12, such as an adaptive cruise control system or an automated emergency braking system.

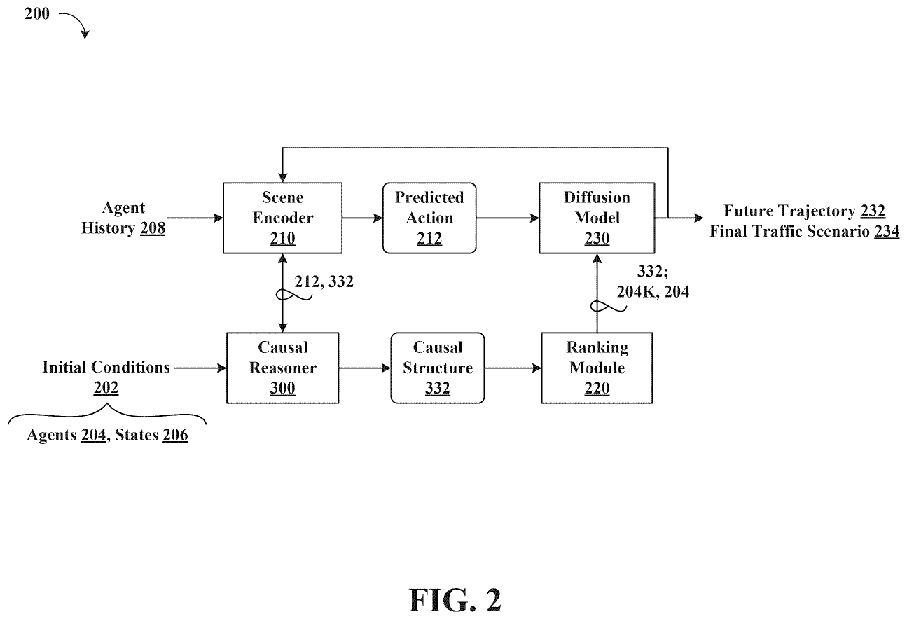

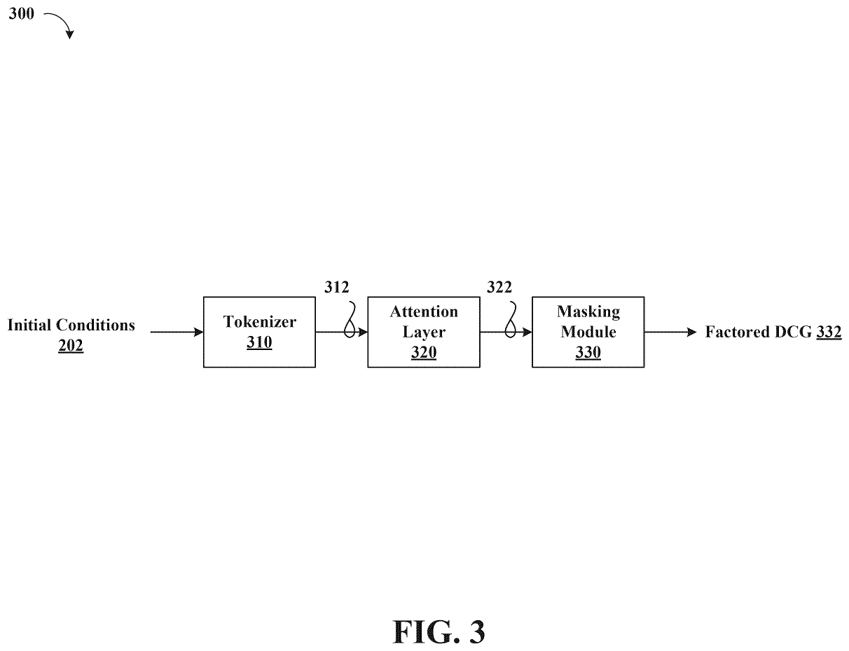

Referring to FIGS. 2 and 3, the casual composition diffusion model 200 includes a scene encoder 210, a causal reasoner 300, a ranking module 220, and a diffusion model 230. The scene encoder 210 is configured receive, as input, the history 208 of previous traffic scenarios, and perform structured scene encoding to encode the history 208 to generate, as output, a predicted action 212 of the history 208. The causal composition diffusion model 300 is configured to receive, as input, the initial conditions 202 for a traffic scenario including a plurality of interacting agents 204. Here, the initial conditions 202 define states 206 of each of the plurality of interacting agents 204. The casual composition diffusion model 300 is configured to identify a casual structure 332 among the plurality of agents 204 based on the states 206 of the plurality of agents 204.

As shown in FIG. 2, the casual reasoner 300 generates, as output, the casual structure 332 defining the casual influences between the agents 204 of the plurality of agents 204. In some implementations, the casual structure 332 includes a decision causal graph (DCG) having a plurality of nodes representing agents 204 and edges representing causal dependencies for future actions. In some cases, the DCG of the casual structure 332 is generated using the scene encoder 210 using a factorized attention mechanism. Here, the casual connections may be identified based at least on one of attention weights or kinematic factors between the plurality of agents 204. These kinematic factors may include a time-to-collision (TTC) value between pairs of agents 204 of the plurality of agents 204.

With reference to FIG. 3, the casual reasoner 300 may include a tokenizer 310, an attention layer 320, and a masking module 330 that cooperate to generate the casual structure 332 (e.g., a factored DCG). Here, the casual reasoner 300 encodes the motion histories 208 of different agents 204 in the initial conditions 202 based on spatial attention, then discovers the DCG based on the factorized attention masks and kinematic factors. Finally, the casual reasoner optimizes its controllability by masking out the non-key agents 204 to guide the reverse sampling process of the diffusion model 230 in a structured way. The tokenizer 310 includes a transformer based structure that is configured to receive, as input, the initial conditions 202, and the history 208, and embed the history 208 of the agents 204 to generate an agent embedding 312. Here the agent embedding 312 includes the history of each agent 204 relative to the history 208 of all the other agents 204 in the initial conditions 202. To facilitate the relational reasoning, both the absolute and relative features of the agents 204 are incorporated, including the position, velocity, distance, and time-to-collision (TTC) of each agent 204 relative to the other agents 204.

Thereafter, the attention layer 320 aggregates all of the temporal information of the agent embedding 312 to generate an attention output 322. To further discover useful spatial parent-to-child relationships, the causal reasoner 300 applies a two-step causal reasoning to identify the DCG 332 in the spatial-temporal interaction of the agents 204. First, by setting a hard constraint over the neighborhood perception field by trimming down the unnecessary causal connection between agents' states 206 and corresponding actions at time-step t. Second, by applying, via the masking module 330, the first tunable hard constraint as a memory mask to the attention weights of the agents 204, as follows:

$${G}_{i j} ( {τ}_{t} ) = {M}_{i j} ( {τ}_{t} ) \cdot softmax ( \frac{( q W q {h}_{t}^{T} ) ( k W k {h}_{t}^{ij} )}{\sqrt{{d}_{k}}} ) . \qquad ( 1 )$$

Here, M denotes the memory mask extracted with relative TTC features. The surrounding agents 204 for each respective agent 204 in the initial conditions 202 is given a threshold C of the DCG 332, as follows:

$${M}_{i j} ( {τ}_{t} ) = \{ \begin{matrix}1 , {f}_{TTC} ( {∅}_{others} ( {s}_{t}^{j \to i} ) \leq {C}_{TTC} \\ 0 , otherwise\end{matrix} . \qquad ( 2 )$$

The masking module 330 may tune the threshold C to control the sparsity of the final DCG 332s such that the diffusion model 230 aggregates the map information c and the state of casual parental agents 204 to get a final action for the future trajectory 234 of the agent 204.

The ranking module 220 is configured to receive, as input, the casual structure 332 including the plurality of agents 204 and their respective causal influences, and rank the plurality of agents 204 to determine a subset of key agents 204K that are the most influential with respect to a controllability objective of the casual composition diffusion model 200. In other words, the ranking module 220 performs a top-K guidance of the most influential agents 204 in the casual structure 332 to identify the subset of key agents 204K. In some cases, the ranking module 220 performs a graph-based analysis on the identified casual structure 332 to determine a degree of interactivity for each agent 204 of the plurality of agents 204. The ranking module 220 may generate, as output, the subset of key agents 204K for the diffusion model 230.

Thereafter, the diffusion model 230 receives, as input, the casual structure 332 including the agents 204 and the subset of key agents 204K, and the predicted action 212 generated by the scene encoder 210 as input and generates, as output, a future trajectory 232 for each agent 204 in the casual structure 332. The diffusion model 230 may generate each future trajectory 232 using a reverse sampling process. In some instances, the diffusion model is a denoising diffusion probabilistic model (DDPM), where the reverse sampling process iteratively denoises a noise vector to produce each of the future trajectories 232 of the agents 204. Notably, the casual composition diffusion model 200 is configured to guide the reverse sampling process of the diffusion model 230 by selectively applying a gradient of the controllability objective only to the determined subset of key agents 204K. Here, the guidance for the remaining agents 204 is determined based on the casual structure 332 determined by the causal reasoner. By bifurcating the guidance of the reverse sampling process, the diffusion model 230 generates a final traffic scenario 234 of all of the future trajectories 232 of the agents 204 that satisfies the controllability objective while maintaining realism.

The causal composition diffusion model 200 may factorize the controllability objective by formulating a closed-loop traffic simulation as a Markov Decision Process (MDP) problem, and utilize a diffusion model 230 (FIG. 2) for sequential modeling to learn a controllable simulation policy. In order to exploit the causal structure between a state 206, action, and reward space, the causal composition diffusion model 200 is defined by a constrained factored MDP and a decision causal graph (i.e., a causal structure 332. The constrained factored MDP (CFMDP) is an MDP where the state space S and reward function R are factorized to exploit the structure of the problem. A CFMDP is defined by the tuple: M_{F}=(S, A, P. R, C, s₀). Here, S denotes the factored state space representing a motion trajectory space at a current time step t for each agent 204, and A denotes the factored action space which consists of interventions on the subsequent deriving behaviors for each agent 204 in the scenario. P denotes the joint transition dynamics defined over the state S and the action A pairs, and defines the deterministic vehicle dynamics for each agent 204 in the setting. R denotes the reward objective of collision, off-road events, over-speed, or other objectives, where each subset of R specifies the state factors impacting the reward. C denotes the constraint function indicating the realism level of generate trajectories of the learned simulation policy with respect to dataset policies, where a lower constraint value implies greater realism. The initial state is denoted by so, which lies in a factored state space s.

As noted above, for every timestep t the causal structure 332 is defined as G where Gᵢⱼ=0 if and only if the future action of a particular agent 204 is conditionally independent of the history 208 of the agent 204. Where G_{2,3}=1, the casual structure 332 includes a causal edge for that particular agent 204. Given the above, the causal composition diffusion model 200 defines a set policy where causal parents of each agent 204 in the casual structure 332 are used in making decisions in identifying the casual structure 332. Given the CFMDP, and with known vehicle dynamics, the causal composition diffusion model 200 factorizes the objective of the optimal closed-loop scenario generation, as follows:

$$\begin{matrix}max P ( {ϑ}_{t} = 1 , {τ}_{t} \vert {τ}_{t - 1} ) ↔ max P ( {ϑ}_{t} = 1 \vert {τ}_{t} ) P ( {τ}_{t} \vert {τ}_{t - 1} ) ↔ \\ \frac{max P}{π} ( {ϑ}_{t} = 1 \vert {s}_{t} {a}_{t} ) π ( {a}_{t} {s}_{t} ) P ( {s}_{t} \vert {s}_{t - 1} {a}_{t - 1} ) ↔ \\ \frac{max}{π} {\prod }_{j = 1}^{{d}_{r}} exp ( {R}^{j} ( {s}_{t}^{{I}_{j}} π ( {s}_{t} ) ) ) {\prod }_{i = 1}^{N} {π}^{i} ( {a}_{t}^{i} \vert {s}_{t} )\end{matrix} , \qquad ( 3 )$$

where the first term corresponds to controllability (i.e., the likelihood of optimality specified by some user-specified reward objective) and the second term corresponds to the realism (i.e., the likelihood of generated behaviors in the future trajectory 232). Thereafter, the score function of the maximum likelihood objective can be expressed, as follows:

$$∇ log P = {\sum }_{j = 1}^{{d}_{r}} {∇}_{τ} {R}^{j} ( {s}_{t}^{{I}_{j}} π ( {s}_{t} ) ) + {\sum }_{i = 1}^{N} {∇}_{τ} log {π}^{i} ( {a}_{t}^{i} \vert {s}_{t} ) . \qquad ( 4 )$$

Unlike the normal scenarios where optimizing the imitation basically adheres with the rule compliance reward, safety-critical guidance R (3) can suffer from gradient conflict. To resolve these gradient conflicting issues, the causal composition diffusion model 200 prioritizes to control the index of agents 204 and maximizes the reward while maintaining a high likelihood of the learned policies, i.e., a lower realism gap between the learned policies and behavior policies. Here, the diffusion model 230 may use a Lagrangian multiplier and structured projected gradient descent to solve the constrained optimization with the following maximum likelihood estimation problem:

$${max}_{π ∈ , ρ ∈ {\{ 0 , 1 \}}^{N} , G ∈ {\{ 0 , 1 \}}^{N \times N}} {\prod }_{j = 1}^{{d}_{r}} exp ( {R}^{j} ( {τ}_{t}^{{I}_{j}} ; ρ ) ) {\prod }_{i ∈ [ N ] {ρ}_{i} = 1} {π}^{i} ( {a}_{t}^{i} \vert {PA}_{t}^{G} ( i ) ) , \qquad ( 5 )$$

subject to |G|<C_{sparsity}, Σᵢβᵢ≤N_{c} where the realism level can be controlled by changing the constraint level of N_{c}, C_{sparsity} ∈ Z⁺.

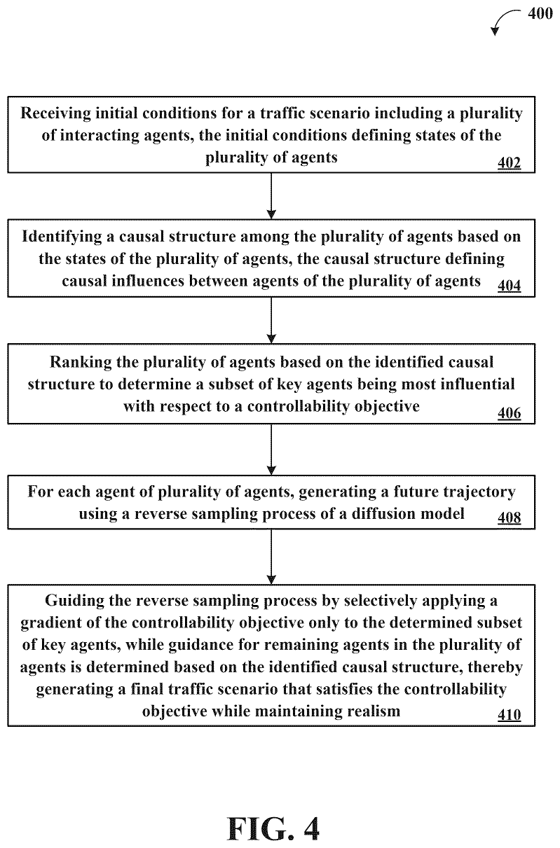

FIG. 4 includes a flowchart of an exemplary arrangement of operations for a method 400 of causal composition diffusion for closed loop traffic generation. The method 400 may be described with reference to FIGS. 1-3. Data processing hardware (e.g., data processing hardware 52 of FIG. 1) may execute instructions stored on memory hardware (e.g., memory hardware 54 of FIG. 1) to perform the example arrangement of operations for the method 400. At operation 402, the method 400 includes receiving initial conditions 202 for a traffic scenario including a plurality of interacting agents 204, the initial conditions 202 defining states 206 of the plurality of agents 204. At operation 404, the method 400 includes identifying a causal structure 332 among the plurality of agents 204 based on the states 206 of the plurality of agents 204. Here, the causal structure 332 defines causal influences between agents 204 of the plurality of agents 204.

At operation 406, the method 400 also includes ranking the plurality of agents 204 based on the identified causal structure 332 to determine a subset of key agents 204K being most influential with respect to a controllability objective. For each agent 204 of the plurality of agents 204, the method 400 also includes, at operation 408, generating a future trajectory 232 using a reverse sampling process of a diffusion model 230. At operation 410, the method 400 further includes guiding the reverse sampling process by selectively applying a gradient of the controllability objective only to the determined subset of key agents 204K. Here, guidance for the remaining agents 204 in the plurality of agents 204 is determined based on the identified causal structure 332, thereby generating a final traffic scenario 234 that satisfies the controllability objective while maintaining realism.

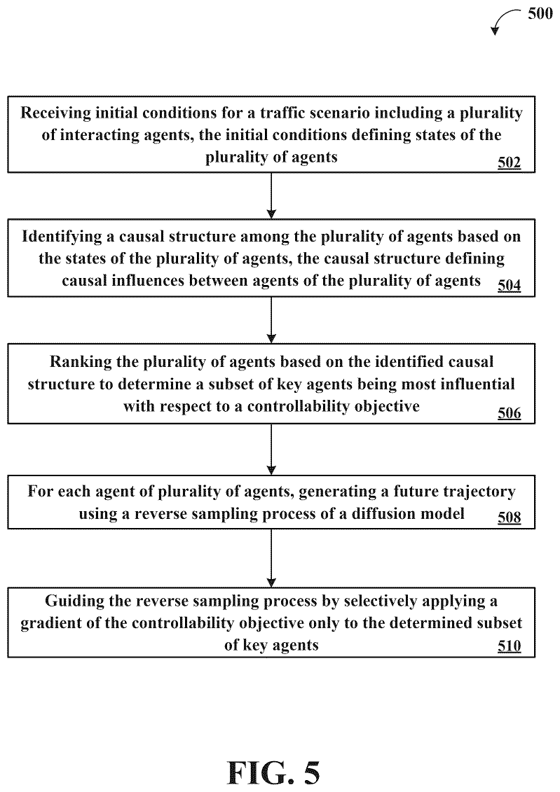

FIG. 5 includes a flowchart of an exemplary arrangement of operations for a method 500 of causal composition diffusion for closed loop traffic generation. The method 500 may be described with reference to FIGS. 1-3. Data processing hardware (e.g., data processing hardware 52 of FIG. 1) may execute instructions stored on memory hardware (e.g., memory hardware 54 of FIG. 1) to perform the example arrangement of operations for the method 500. At operation 502, the method 500 includes receiving initial conditions 202 for a traffic scenario including a plurality of interacting agents 204, the initial conditions 202 defining states 206 of the plurality of agents 204. At operation 504, the method 500 includes identifying a causal structure 332 among the plurality of agents 204 based on the states 206 of the plurality of agents 204, Here, the causal structure 332 defines causal influences between agents 204 of the plurality of agents 204.

At operation 506, the method 500 also includes ranking the plurality of agents 504 based on the identified causal structure 332 to determine a subset of key agents 204K being most influential with respect to a controllability objective. For each agent 204 of the plurality of agents 204, the method 500 also includes, at operation 508, generating a future trajectory 232 using a reverse sampling process of a diffusion model 230. At operation 510, the method 500 further includes guiding the reverse sampling process by selectively applying a gradient of the controllability objective only to the determined subset of key agents 204K.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A computer-implemented method when executed on data processing hardware causes the data processing hardware to perform operations comprising:
receiving initial conditions for a traffic scenario comprising a plurality of interacting agents, the initial conditions defining states of the plurality of agents;
identifying a causal structure among the plurality of agents based on the states of the plurality of agents, the causal structure defining causal influences between agents of the plurality of agents;
ranking the plurality of agents based on the identified causal structure to determine a subset of key agents being most influential with respect to a controllability objective;
for each agent of the plurality of agents, generating a future trajectory using a reverse sampling process of a diffusion model; and
guiding the reverse sampling process by selectively applying a gradient of the controllability objective only to the determined subset of key agents, while guidance for remaining agents in the plurality of agents is determined based on the identified causal structure, thereby generating a final traffic scenario that satisfies the controllability objective while maintaining realism.

2. The method of claim 1, wherein identifying the causal structure comprises generating a Decision Causal Graph (DCG), nodes of the DCG representing agents and edges representing causal dependencies for future actions.

3. The method of claim 2, wherein the DCG is generated using a scene encoder with a factorized attention mechanism, and wherein causal connections are identified based on at least one of attention weights or kinematic factors between the plurality of agents.

4. The method of claim 3, wherein the kinematic factors include a time-to-collision (TTC) value between pairs of agents of the plurality of agents.

5. The method of claim 1, wherein ranking the plurality of agents comprises performing a graph-based analysis on the identified causal structure to determine a degree of interactivity for each agent of the plurality of agents.

6. The method of claim 1, wherein guiding the reverse sampling process further comprises applying a classifier-free guidance component, the classifier-free guidance component comprising a weighted combination of an unconditional distribution based on an agent's own history and an intervened distribution based on causal parents of the agent as defined by the causal structure.

7. The method of claim 1, wherein the controllability objective is associated with generating a safety-critical event.

8. The method of claim 7, wherein the safety-critical event comprises one of a collision between at least two agents, an off-road event for at least one agent, or a near-miss event.

9. The method of claim 1, wherein the diffusion model is formulated as a constrained optimization problem within a Constrained Factored Markov Decision Process (CFMDP), the controllability objective maximized subject to a realism constraint.

10. The method of claim 1, wherein the diffusion model is a denoising diffusion probabilistic model (DDPM) and the reverse sampling process iteratively denoises a noise vector to produce each of the future trajectories.

11. A system comprising:
data processing hardware; and
memory hardware in communication with the data processing hardware, the memory hardware storing instructions that when executed on the data processing hardware cause the data processing hardware to perform operations comprising:
receiving initial conditions for a traffic scenario comprising a plurality of interacting agents, the initial conditions defining states of the plurality of agents;
identifying a causal structure among the plurality of agents based on the states of the plurality of agents, the causal structure defining causal influences between agents of the plurality of agents;
ranking the plurality of agents based on the identified causal structure to determine a subset of key agents being most influential with respect to a controllability objective;
for each agent of the plurality of agents, generating a future trajectory using a reverse sampling process of a diffusion model; and
guiding the reverse sampling process by selectively applying a gradient of the controllability objective only to the determined subset of key agents, while guidance for remaining agents in the plurality of agents is determined based on the identified causal structure, thereby generating a final traffic scenario that satisfies the controllability objective while maintaining realism.

12. The system of claim 11, wherein identifying the causal structure comprises generating a Decision Causal Graph (DCG), nodes of the DCG representing agents and edges representing causal dependencies for future actions.

13. The system of claim 12, wherein the DCG is generated using a scene encoder with a factorized attention mechanism, and wherein causal connections are identified based on at least one of attention weights or kinematic factors between the plurality of agents.

14. The system of claim 13, wherein the kinematic factors include a time-to-collision (TTC) value between pairs of agents of the plurality of agents.

15. The system of claim 11, wherein ranking the plurality of agents comprises performing a graph-based analysis on the identified causal structure to determine a degree of interactivity for each agent of the plurality of agents.

16. The system of claim 11, wherein guiding the reverse sampling process further comprises applying a classifier-free guidance component, the classifier-free guidance component comprising a weighted combination of an unconditional distribution based on an agent's own history and an intervened distribution based on causal parents of the agent as defined by the causal structure.

17. The system of claim 11, wherein the controllability objective is associated with generating a safety-critical event, the safety-critical event comprising one of a collision between at least two agents, an off-road event for at least one agent, or a near-miss event.

18. The system of claim 11, wherein the diffusion model is formulated as a constrained optimization problem within a Constrained Factored Markov Decision Process (CFMDP), the controllability objective maximized subject to a realism constraint.

19. The system of claim 11, wherein the diffusion model is a denoising diffusion probabilistic model (DDPM) and the reverse sampling process iteratively denoises a noise vector to produce each of the future trajectories.

20. A computer-implemented method when executed on data processing hardware causes the data processing hardware to perform operations comprising:
receiving initial conditions for a traffic scenario comprising a plurality of interacting agents, the initial conditions defining states of the plurality of agents;
identifying a causal structure among the plurality of agents based on the states of the plurality of agents, the causal structure defining causal influences between agents of the plurality of agents;
ranking the plurality of agents based on the identified causal structure to determine a subset of key agents being most influential with respect to a controllability objective; and
for each agent of the plurality of agents, generating a future trajectory using a reverse sampling process of a diffusion model, the reverse sampling process guided by selectively applying a gradient of the controllability objective only to the determined subset of key agents.
